(19) United States
(12) Patent Application Publication
(10) Pub. No.: US 2025/0021779 A1
(43) Pub. Date: Jan. 16, 2025

(54) QR CODE ANALYZER

(71) Applicants: Scott Wood, Tempe, AZ (US); Erica Liebmann, Scottsdale, AZ (US)

(72) Inventors: Scott Wood, Tempe, AZ (US); Erica Liebmann, Scottsdale, AZ (US)

(21) Appl. No.: 18/770,355

(22) Filed: Jul. 11, 2024

Related U.S. Application Data
(60) Provisional application No. 63/513,034, filed on Jul. 11, 2023.

(51) Int. Cl. G06K 7/14

(52) U.S. Cl. CPC G06K 7/1417

(57) ABSTRACT

A method for analyzing QR codes. The method utilizes a sandbox environment to test resources linked by the QR code. The method tests each linked resource while proceeding through the redirection chain. The method determines whether each resource in the chain contains threats. The method determines an overall safety rating for the QR code based on testing each resource in the redirection chain. The method presents the redirection chain and the safety rating to a user.

### FIELD OF THE INVENTION

The present invention relates generally to cybersecurity. The present invention relates more specifically detecting security threats over a network.

### BACKGROUND OF THE INVENTION

Quick Response (QR) codes are 2-dimensional matrix barcodes that hold information that may be executable. Many mobile devices contain cameras and/or QR code reading applications. QR codes may contain executable URL links that will open a web browser application then redirect to a specific site. However, QR codes can also be used to execute security protocols, open other non-web browsing applications, or even install cookies or dormant malware onto the mobile device. Many restaurants utilize a QR code to direct a customer to a payment website for contactless payment. One strategy for cyberthieves is to replace the payment link QR codes with interceptor QR codes using a stick with the alternative QR and placing it over the original QR code undetected. There are many potentially undiscovered mal-intent uses of QR codes that have yet to be discovered.

It is an objective of the present invention to analyze QR codes to determine whether the linked resource is safe. It is a further objective of the present invention to detect redirects through multiple resources. It is a further objective of the present invention to detect threats contained within the linked resources.

### SUMMARY OF THE INVENTION

The present invention represents a method for analyzing QR codes. When a user scans a QR code, the method utilizes a sandbox environment to test resources linked by the QR code. The method tests each linked resource while proceeding through the redirection chain. The method determines whether each resource in the chain contains threats. The method determines an overall safety rating for the QR code based on testing each resource in the redirection chain. The method presents the redirection chain and the safety rating to the user.

### BRIEF DESCRIPTION OF THE DRAWINGS

FIG. 1 is a flowchart of Embodiment 1 of the present invention.

FIG. 2 is a flowchart of Embodiment 1 of the present invention.

FIG. 3 is a block diagram of a computing system capable of operating Embodiment 1 of the present invention.

FIG. 4 is a block diagram of a computing system capable of operating Embodiment 1 of the present invention.

### DETAILED DESCRIPTION OF THE INVENTION

All illustrations of the drawings are for the purpose of describing selected versions of the present invention and are not intended to limit the scope of the present invention.

The present invention represents a Quick Response (QR) code analyzer. QR codes are inherently risky from a cybersecurity perspective. Many threats may be invisible to the end user. The present invention provides a solution to threats of unsecure QR codes.

The present invention evaluates the threat and presents the results to the user to allow the user to make an informed decision whether to follow a link provided by a QR code.

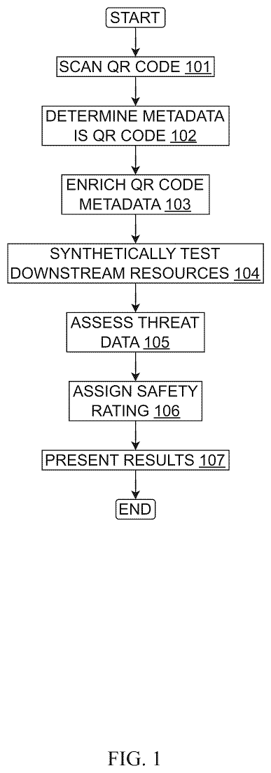

Referring to FIG. 1, Embodiment 1 of the present invention comprises a method for analyzing QR codes. At step 101, the computing device scans a QR code. In Embodiment 1, the computing device initialized a camera or other optical device attached to the computing device. The computing device may execute augmented reality tools to scan the QR code. For example, the computing device may execute Apple AR Kit. The camera or optical device of the computing device captures an image of the QR code. The augmented reality tools digest the image of the QR code into metadata.

At step 102, the computing device determines whether the metadata retrieved by digesting the QR code is a QR code. The computing device determines whether the metadata is a QR code metadata type by comparing the metadata to known signatures.

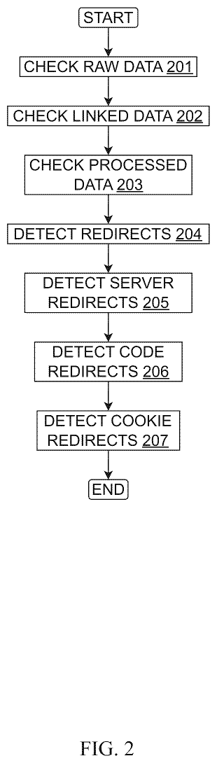

At step 103, the computing device enriches the QR code metadata. The enriching step is described in further detail in FIG. 2. In Embodiment 1, the computing device identifies redirects in the QR code metadata, which link to downstream resources.

At step 104, the computing device synthetically tests the downstream resources. In Embodiment 1, the computing device utilizes a cybersecurity sandbox to follow each of the identified redirects. The computing device performs a static analysis of each of the downstream resources. The computing device tests for malware threats, privacy threats, and tracking threats. The computing device looks for signatures of malware within each of the downstream resources. The computing device compares the signatures of the downstream resources against a large language model (LLM) of known signatures. The computing device may utilize fuzzy matching to compare the signatures of the downstream resources to the known signatures. The computing device may assign a confidence score based on how closely the signature matches a known threat. The computing device tests the tracking data of the resource for oddities. In Embodiment 1,the computing device synthetically tests each downstream resource before redirecting to the next downstream resource. As the computing device redirects to each downstream resource, the computing device builds a redirection chain, showing each downstream resource that is encountered before being redirected to the final resource.

At step 105, the computing device assesses the threat data. In Embodiment 1, the computing device categorizes the type of threat detected during the synthetic testing. For example, the categories may include known malware threats, privacy threats, tracking threats, and safe resources.

At step 106, the computing device assigns a safety rating based on the testing. In Embodiment 1, the QR code is rated red where a known malware threat was detected. The QR code is also rated red where privacy threats are detected. The QR code is rated orange where a privacy threat is detected, but the user is likely to accept the threat to access the website. For example, if the website for a popular coffee shop has privacy threats but the user must use the website to access their account or gift card balance, the computing device may rate the QR code orange. The QR code is rated yellow where tracking threats are detected or acceptable minimal threats are detected. The acceptable minimal threats are established via opinionated means. The QR code is rated green where no threats are detected. In some embodiment, a green rating may have additional requirements, such as HTTPS implementation, known safe cookies, and fewer redirects than a pre-defined threshold.

At step 107, the computing device presents the results of the testing to the user. In Embodiment 1, the computing device presents the color rating and a redirect chain. The redirect chain shows each of the downstream resources through which the connection will be redirected if the user accesses the QR code. The computing device presents a red ‘X’ to the user where a known malware threat or a fishy threat is detected. Where a known threat is detected for a popular website where the user is likely to proceed despite the threat, the computing device presents an orange ‘X’. Where a tracking threat is detected but not a known malware threat, the computing device presents a yellow check mark and a learn more button. Where no threats are detected, the computing device presents a green check mark.

Referring to FIG. 2, Embodiment 1 of the present invention further comprises a method for enriching the QR code. At step 201, the computing device checks the raw data contained in the QR code.

At step 202, the computing device checks the data linked by the QR code.

At step 203, the computing device checks the processed data. Checking the processed data includes checking for redirects at step 204. The computing device tests for redirects that redirect to malware. At step 205, the computing device checks for redirects performed by the server hosting the resource. At step 206, the computing device checks for redirects contained in the code of the resource. For example, the computing device checks for a JavaScript redirect contained with the code of a website. At step 207, the computing device checks for redirects contained with a cookie downloaded from the resource.

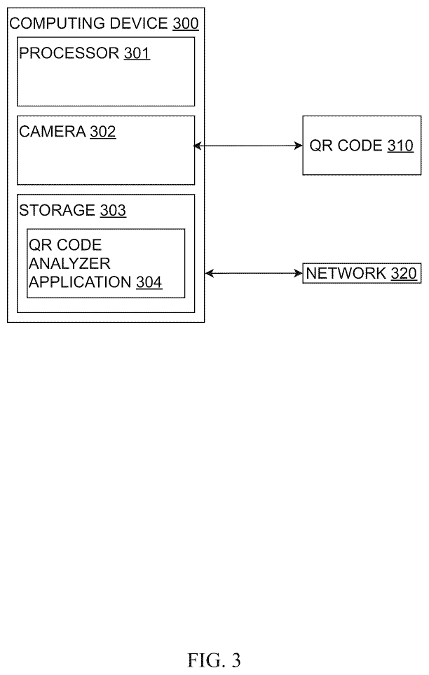

Referring to FIGS. 3, a system capable of executing Embodiment 1 of the present invention is shown. The computing device 300 is a device capable of executing the methods described in FIGS. 1-2. In Embodiment 1, the computing device 300 is a mobile device. In alternate embodiments, the computing device 300 may be a tablet, laptop computer, desktop computer, smart glasses, wearable device, or CCTV camera. The computing device includes a processor 301, camera 302, and storage 303. The computing device 300 includes additional components that are necessary for the functioning of the computing device, which are not shown.

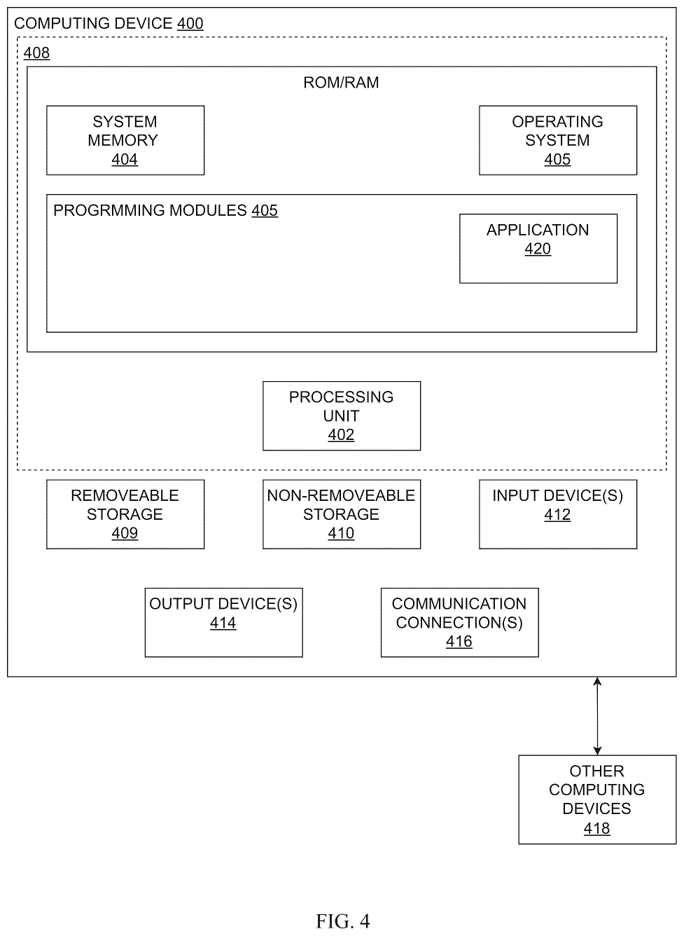

With reference to FIG. 4, a system consistent with Embodiment 1 of the present invention may include a computing device, such as computing device 400. Computing device 400 can represent computing device 300. In a basic configuration, computing device 400 may include at least one processing unit 402 (e.g., control circuit 110) and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400′s operation. In one embodiment, programming modules 406 may include machine learning module. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer-readable instructions, data structures, program modules, or other data. System memory 404, removable storage 409, and non-removable storage 410 are all computer storage media examples (i.e., memory storage).

Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, a location sensor, a camera, a biometric sensor, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402 (e.g., control circuit 110), programming modules 406 (e.g., application 420 such as a media player) may perform processes including, for example, one or more stages of methods, algorithms, systems, applications, servers, databases as described above. The aforementioned process is an example, and processing unit 402 may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, virtual reality (VR) systems, augmented reality (AR) systems, wearable devices, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Although the invention has been explained in relation to its preferred embodiment, it is to be understood that many other possible modifications and variations can be made without departing from the spirit and scope of the invention as hereinafter claimed. Although the steps have been presented in an order, it is to be understood that steps may be performed in alternate order and steps may be repeated without departing from the spirit and scope of the invention as hereinafter claimed.

What is claimed is:

1. A computer-implemented method for analyzing QR codes, comprising:
scanning, via a computing device, a QR code with a camera, wherein the camera is connected to the computing device;
determining, via the computing device, metadata associated with the QR code matches a QR code metadata type;
enriching, via the computing device, the metadata associated with the QR code;
synthetically testing, by the computing device, one or more downstream resources identified by the enriching;
assigning, via the computing device, a safety rating to the QR code; and
presenting, via the computing device, the safety rating.

2. The computer-implemented method of claim 1, wherein enriching the metadata associate with the QR code further comprises:
checking, via the computing device, raw data associated with the QR code;
checking, via the computing device, linked data associated with the QR code; and
checking, via the computing device, processed data associated with the QR code.

3. The computer-implemented method of claim 2, wherein checking the processed data associated with the QR code further comprises:
checking, via the computing device, for one or more redirects, wherein the one or more redirects are associated with the one or more downstream resources; and
testing, via the computing device, the one or more downstream resources for one or more signatures of malware.

4. The computer-implemented method of claim 3, wherein checking for one or more redirects further comprises:
checking, via the computing device, for one or more server redirects;
checking, via the computing device, for one or more code redirects; and
checking, via the computing device, for one or more cookie redirects.

5. The computer-implemented method of claim 1, wherein synthetically testing the downstream resources identified by the enriching further comprises testing, by the computing device, for one or more signatures of malware.

6. The computer-implemented method of claim 1, wherein synthetically testing the downstream resources identified by the enriching further comprises testing, by the computing device, for one or more privacy threats.

7. The computer-implemented method of claim 1, wherein synthetically testing the downstream resources identified by the enriching further comprises testing, by the computing device, for one or more tracking threats.

8. The computer-implemented method of claim 1, further comprising:
building, via the computing device, a redirection chain, wherein the redirection chain lists each of the one or more downstream resources; and
presenting, via the computing device, the redirection chain.

9. A system for analyzing QR codes, comprising:
at least one non-transitory computer-readable medium configured to store instructions;
a camera; and
at least one processor configured to execute the instructions to perform operations comprising:
scanning a QR code with a camera, wherein the camera is connected to the computing device;
determining metadata associated with the QR code matches a QR code metadata type;
enriching the metadata associated with the QR code;
synthetically testing one or more downstream resources identified by the enriching;
assigning a safety rating to the QR code; and
presenting the safety rating.

10. The system of claim 9, wherein enriching the metadata further comprises:
checking raw data associated with the QR code;
checking linked data associated with the QR code; and
checking processed data associated with the QR code.

11. The system of claim 10, wherein checking the processed data associated with the QR code further comprises:
checking for one or more redirects, wherein the one or more redirects are associated with the one or more downstream resources; and
testing the one or more downstream resources for one or more signatures of malware.

12. The system of claim 11, wherein checking for one or more redirects further comprises:
checking, via the computing device, for one or more server redirects;
checking, via the computing device, for one or more code redirects; and
checking, via the computing device, for one or more cookie redirects.

13. The system of claim 9, wherein synthetically testing the downstream resources identified by the enriching further comprises:
testing for one or more signatures of malware;
testing for one or more privacy threats; and
testing for one or more tracking threats.

14. The system of claim 9, the operations further comprising:
building a redirection chain, wherein the redirection chain lists each of the one or more downstream resources; and
presenting the redirection chain.

15. A non-transitory computer readable medium comprising instructions, which when executed by at least one processor, cause the at least one processor to perform operations for analyzing QR codes, the operations comprising:
scanning a QR code with a camera, wherein the camera is connected to the computing device;
determining metadata associated with the QR code matches a QR code metadata type;
enriching the metadata associated with the QR code;
synthetically testing one or more downstream resources identified by the enriching;
assigning a safety rating to the QR code; and
presenting the safety rating.

16. The non-transitory computer readable medium of claim 15, wherein enriching the metadata further comprises:
checking raw data associated with the QR code;
checking linked data associated with the QR code; and
checking processed data associated with the QR code.

17. The non-transitory computer readable medium of claim 16, wherein enriching the metadata further comprises:
checking for one or more redirects, wherein the one or more redirects are associated with the one or more downstream resources; and
testing the one or more downstream resources for one or more signatures of malware.

18. The non-transitory computer readable medium of claim 17, wherein enriching the metadata further comprises:
checking, via the computing device, for one or more server redirects;
checking, via the computing device, for one or more code redirects; and
checking, via the computing device, for one or more cookie redirects.

19. The non-transitory computer readable medium of claim 15, wherein enriching the metadata further comprises:
testing for one or more signatures of malware;
testing for one or more privacy threats; and
testing for one or more tracking threats.

20. The non-transitory computer readable medium of claim 15, wherein enriching the metadata further comprises:
building a redirection chain, wherein the redirection chain lists each of the one or
more downstream resources; and
presenting the redirection chain.
